(19) United States
(12) Patent Application Publication
(10) Pub. No.: US 2015/0081277 A1
(43) Pub. Date: Mar. 19, 2015

(54) System and Method for Automatically Classifying Text using Discourse Analysis

(71) Applicant: Kambiz Behi, Chicago, IL (US)

(72) Inventor: Kambiz Behi, Chicago, IL (US)

(21) Appl. No.: 14/471,623

(22) Filed: Aug. 28, 2014

(51) Int. Cl. G06F 17/27

(52) U.S. Cl. CPC G06F 17/274
USPC 704/9

(57) ABSTRACT

The present invention is a textual discourse analysis with the purpose of analyzing and visualizing of complex text. The invention operates and functions based on conceptual relations, both logical and axiological, among grammatical components of a sentence and across sentences of a given text. Thus, three basic grammatical units, namely Agent/s, Topic/s and Object/s, have been utilized, in order to build a tripartite structure. Discursive analysis of text based on this invention provides a novel approach for automatically classifying positions of Agent/s within particular textual databases vis-a-vis to Topic/s and Object/s, and vice versa. Therefore, as illustrated above, a computer program method of the present invention starts by creating a conceptual map of a given text, classifying semantic macro-areas, positions of Agents, Topics and objects and then correlates such positions with other components in the database. In the next step of the invention, the computer assigns a reference system, provided for analyzing denotative content of discourse. The system is based upon a database of terms of words and phrases and their associated denotative as well as connotative meanings followed by generation of a database, axiologically categorizing subject-matters.

### FIELD OF THE INVENTION

The present invention relates to the field of human-machine dialogue also known as Natural Language Processing (“NLP”). More particularly, the present invention relates to a method and system for identifying and querying interrelation of grammatical components within and across sentences using discourse analysis.

### BACKGROUND

The availability of huge amount of data from a bewildering variety of sources leads to the well-identified paradox of information overdose. An overload of information means no usable knowledge. The advent of technology and substantial over reach of internet across classes and masses has created a web of document from where any user can attempt to trace and find the desired information. Gradually there has been substantial increase in the number and size of electronic documents floating on the interne. Any computer user with access to the interne can search a vast universe of documents addressing every conceivable topic. However, searching and identifying the most relevant information from the available wealth of documents without any aid of technology is a daunting task. In fact, finding a large supply of searchable electronic documents from the wealth of documents is far easier task than searching an individual document germane to a particular query. In such a scenario, there is an acute need for a search engine technology, which not only has the ability to locate words and phrases, but also to uncover the grammatical relations among components of sentences, passages and entire documents. The system of Discourse Analysis creates a system for uncovering grammatical relations between different parts of speech and reorganizes documents based on such grammatical relations.

The globalization has given a substantial boom to the reach of English language across the globe. Textual sources in digital form are pervasive, especially on the Internet where easy access has made it possible for everyone to retrieve vast amount of textual data with click of a search button. The English language has played a vital role in increasing the acceptability of the internet across the globe, due to which the flow of English language documents and enormously large number of textual information has been propagated across the World Wide Web. As the corpora of the English language grow on the internet, managing online searches and getting particular information has become a daunting task. In order to overcome the difficulty of identifying the relevant text/document from the world of documents, several attempts have been made to limit the search, restrict the search into a narrow compass using various analysis viz. text analysis, content analysis, sentiment analysis etc. There has been substantial increase in dependency of the analysis method to enhance the accuracy of search result. The basic limitation, which these analytics tool faces is its search methodology, which they use during search process. Each analysis method is having a standard codified rule, based on which the search result are given and the user is left in midst of those search results, to identify its best suited piece meal.

Several technologies and methodologies of searching are known in the prior art, which disclose various techniques of text analysis and information extraction from text. These prior articles do not incorporate several technical areas, which the present article has advanced. Before discussing the present invention in depth, relevant inventions from prior articles are discussed to shed light on major differences that present invention offers vis-à-vis previous articles.

A U.S. Pat. No. 6,766,320 granted in favor of Hai-Fang Wang et. al. inter alia discloses a natural language based search engine designed to handle a full range of user queries including a simple keyword search to a complex sentence based queries. The system architecture of said search engine includes a sentence parser, a question matcher, a keyword searcher and a log analyzer. The search engine operates in two folds i.e. getting relevant answers from the keyword searcher and question matcher. The sentence parser of the said search engine is in the form of a natural language parser capable of parsing syntactic and semantic information from user queries. The sentence parser after parsing the relevant information returns partially-parsed fragments wherein more accurate or descriptive information is not available in the user query. Based on the fully or partially parsed information, the question matcher prepares a database of frequently asked questions in form of a standard template. The question matcher correlates the user query with the available standard templates, which represent possible solution of the user query. The keyword searcher present in the said search engine locates possible answers of a user query by searching keyword received from the parser. Both the answers received from question matcher as well as keyword searcher are presented to the user to confirm which answer best suits his/her need/requirement. All the activities i.e. user queries, answers returned to the user queries and conformation received from the user are logged into the log analyzer. The log analyzer uses these details to improve the performance of the search engine by training sentence parser and question matcher. However, it is pertinent to note that the system does not include a sentence parsing system based on grammatical parameters and therefore differs from present filing. Particularly missing from the system is discursive parsing of sentences based on Agent, Topic, and Objects within and across sentences and the system does not include features for virtual representation and illustration of inter-relationships of grammatical components in texts.

Another U.S. Pat. No. 4,914,590 granted in the name of Loatman et. al. inter alia discloses a hybrid natural language understanding system for processing natural language text. The essential functional components of the said system include a preprocessor; a word look-up and morphology module; a learning module; a syntactic parser; a case frame applier and a discourse analysis component. The word look-up and morphology module communicates with a lexicon and a learning module. The syntactic parser interfaces with an augmented transition network grammar and the case frame applier, which converts the syntactic structure into canonical, semantic “case frames”. The discourse analysis component integrates the explicit and implied information in the text into a conceptual structure, which represents its meaning. The conceptual structure so formed is passed on to a knowledge based system, a database and to an interested analysts or decision makers etc. The system also provides for a significant feedback points i.e. notification of sementactically incorrect parse by the case frame applier or seeking a semantic judgment based on a fragmentary parse by the syntactic parser. The system employs a novel semantic analysis approach based largely on case grammar. However, this system does not disclose the sentence parsing system based on any grammatical categories. Moreover, the system of discursive parsing of sentences and connecting Agent, Topic, and Objects across texts is not present. Further, the system is silent on the feature of virtual representation depicting the inter-relationship of the words used in a sentence.

Yet another U.S. Pat. No. 7,283,958 granted in favor of Azara et. al. inter alia discloses a system and method for resolving ambiguity in natural language speech. The system employs automatic speech recognition technique for speech recognition. The said system determines a theory of discourse analysis, at least one set of candidate discourse function, prosodic features in the speech and establishes a correlation between the prosodic feature and the discourse function. The system also ranks the set of candidate discourse functions based on the prosodic features in the speech information and a correlation to the prosodic features expected for the prosodic features in the speech. Ambiguity is resolved between sets of candidate discourse functions based on the rank information. However, the system does not discloses an automated parsing and segregating system, wherein the user keys-in the sentence and the system automatically parses the sentence based on a pre-define criteria and returns with accurate search results. Moreover, the system lacks grammatical search within and across sentences. Lastly, the present solution of Agent, Topic, and Object for discursive search and reorganization of textual information is not present.

Another Japanese Patent No. JP 2012003701 granted in the name of Nomura Res Inst Ltd. discloses a discourse summary generation system wherein the discourse data and discourse semantics are used as an input to generate the discourse summary. The said system comprises a summary template and a discourse summarizing part. The said summary template is a pre-defined format in which the summary is prepared. The summary template specifies a reference list of a word juncture pattern for identification of relevant parts, which can be included in the discourse summary. The said disclosure summarizing part matches every pattern specified in the summary template with the disclosure data and if any pattern matches, the said system generates a summarized sentence based on the template of the matched pattern and adds the same sentence to the summary. However, the system is limited to generation of summary template with a reference list of word juncture pattern. The system does not disclose various kinds of visual representations facilitating the user to identify/track the origin of the search results. Moreover, the system does not provide any query technology based on grammatical parsing of sentences.

U.S. Pat. No. 6,796,800 granted in favor of Burstein et. al. discloses methods for automated essay analysis. The said method includes inter alia identifying presence of predetermined set of features in each essay, calculating probability of each sentence in the essay being a member of a certain disclosure element category based on the presence of predetermined features. Further, based on calculated probabilities, a sentence is chosen as the choice for discourse element category. However, the present invention is silent on presentation of the information and lacks any methodology for parsing sentences based on grammatical structures of sentences, paragraphs, and larger texts.

Yet another U.S. Pat. No. 8,200,477 granted in the name of Jeonghee Yi et. al. inter alia discloses a method and system for extracting opinions from text documents after analyzing each sentence of the text documents based on the most relevant feature terms. The most relevant feature terms are in the form of definite noun phrases at the beginning of the sentence. For each sentence, referring to a subject or a feature term, the invention determines as to whether the sentence includes an opinion polarity about the subject or feature term. The opinion polarity is determined by indentifying opinion terms in the sentence using an opinion dictionary, opinion rule base, parting the sentence with an English parser to identify grammatical components in the sentence and its relationships and finding a matching entry in the dictionary or the rule base. However, the said invention does not disclose various search criteria to segregates the search and prepare a detailed visualized map to achieve the most relevant search results. Moreover, the invention does not parse sentences based on Agent, Topic, and Object and more importantly, it lacks the capability to discursively interconnect grammatical components across sentences.

A U.S. Pat. No. 6,363,373 granted in the name of Steinkraus et. al discloses a search engine technology, wherein inter alia, the documents are processed on a word-by-word basis also called as “word tokens” contained in the document before being passed to a search engine. After extraction of word tokens from the document, each word token is referenced in a concept database that maps the word tokens with concept identifiers. The said concept identifiers associated with the word tokens are converted into a unique non-word concept token and are arranged into a list. The said list so formed is inserted into a document as invisible but searchable text and said document is transferred to the server monitored by the search engine. The search queries entered are similarly preprocessed as documents before being passed to the search engine. The query is broken into word tokens, which are referenced in the concept database. All the relevant concept identifiers associated with the concept database are retrieved and converted to unique concept tokens. The said concept tokens are combined to form a string, which is sent to the search engine as an ordinary query. In such an exercise, at times the importance, significance and context of the document are lost. A few of the advanced search engines, allows the user to refine the search results using Boolean logic, limiting the number of key words etc. Due to the design of the system, the user has to peruse each and every document retrieved as search results and text analyzers and classifiers are generic in nature. The present invention does not offer a grammatical parsing and lacks a technology for grammatically uniting texts based of Agent, Topic, and Object.

Another prior art i.e. U.S. Pat. No. 847,349 issued to Anderson et. al. inter alia discloses a method and system of text analytics. The said invention comprises the following steps including inter alia filtering a plurality of unfiltered records having unstructured data into at least a first group and a second group. The first and second groups have at least two records and are different from each other. The said invention determines a first proportion of occurrence for a term by comparing a first number of records having at least one occurrence of the term in the first group to a first total number of records in the first group, determining a second proportion of occurrence for the term by comparing a second number of records having at least one occurrence of the term in said second group to a second total number of records in the second group, and comparing the first proportion of occurrence to the second proportion of occurrence to yield a resultant comparison occurrence. The said prior art uses comparative analysis method wherein the occurrence of each term is calculated and compared with the error range and based on the number of occurrence, the relevant document is classified into a specific record group. The prior art as discussed herein does not discloses the method of classifying the documents based on statistical methods, which are more scientific and accurate. Furthermore, the prior art does not discloses the method of identifying the denotative and connotative content without which the context and relevance of the search results cannot be assured. Lastly, the present art differs from resent invention in that it does not have the capability to parse documents based on grammatical relations among components of sentences or across sentences and paragraphs.

Similarly, another prior art issued as the U.S. Pat. No. 7,672,831 to Todhunter et. al inter alia discloses a system and method for cross-language knowledge searching. The system comprising a semantic analyzer, a natural language user request/document search pattern/semantic index generator, a user request search pattern translator and a Knowledge Base Searcher. The said system is capable of providing automatic semantic analysis and semantic indexing of natural language user requests/documents on knowledge recognition and cross-language relevant to user request knowledge extraction/searching. The invention also employs a Linguistic Knowledge Base as well as a number of unique bilingual dictionaries of concepts/objects and action to ensure the system functionality. However, the system lacks grammatical parsing and capability to make queries about grammatical components of in texts.

Yet another prior art in the form of U.S. Pat. No. 6,741,992 issued to McFadden inter alia discloses a system based on rule-based text classification, which classifies documents according to rules written by people about the relationship between words in the documents and the classification categories. The said system allows the users to control and influence the flow and access of the information. The users include allows information originators, administrators, recipients, and requesters. The originators generate messages or evaluate external content and specify rules indicating the type of recipient to which the generated messages or evaluated contents should reach. The recipients specify the rule indicating from what type of originators and what type of messages should reach them. Users have the facility to provide profile information and can have incentive to provide as much information as possible to facilitate triggering of right rules. The text classification systems, which rely upon rule-based techniques, also suffer from several limitations. The most significant limitation is that such systems require a significant amount of knowledge engineering to develop a working system appropriate for a desired text classification application. It becomes more difficult to develop an application using rule-based systems because individual rules are time-consuming to prepare, and require complex interactions. A knowledge engineer must spend a large amount of time tuning and experimenting with the rules to arrive at the correct set of rules to ensure that the rules work together properly for the desired application. There is no solution presently available for uncovering positions of various agents in relation to a particular issue from a given textual source. The system, moreover, lack a grammatical parsing options and discursive reorganization of textual information.

Another prior art in the form of U.S. Pat. No. 8,423,350 issued to Chandra Sunil et. al. inter alia discloses a system, method and apparatus for segmenting text for searching. The said system and method includes receiving text, segmenting received text into one or more unigrams, filtering one or more unigrams to identify one or more core unigrams. Identification of one or more unigrams includes identification and indexing of stem, associating one or more second n-grams with the indexed stem.

Each of the one or more second n-grams is derived from the text and includes a core unigram that is related to the indexed stem. However, as and when the number of columns for the purpose of segmentation is increased the n-gram computational method, there is a significant fall in the accuracy of regression prediction. The system does not provide for a grammatical parsing mechanism.

Yet another prior art in the form of U.S. Pat. No. 8,306,808 issued to Elbaz et. al. inter alia discloses a method and system for selecting a language for text segmentation. The said invention includes identification of a first candidate language and a second candidate language associated with a string of characters followed by determination of first and second segment result associated with first and second candidate language respectively. The system further determines a first frequency of occurrence for the first segmented result and a second frequency of occurrence for the second results and identification of an operable language from the first candidate language and the second language based at least in part on the first frequency of occurrence and the second frequency of occurrence. However, the prior art does not discloses grammatical relationships discursively to implement a cross referential system amongst sentences and paragraphs. Moreover, a system for isolating and visually representing the selection and text segmentation with tagged Agents is not present.

Yet another prior in the form of U.S. Pat. No. 8,136,034 issued to Stanton Aaron inter alia discloses a system and method for analyzing elements of text for comparative purposes. In the said invention, text is provided as an input in an electronic format, which can be readable by the system. The system has a database of scenes from which various values are generated. The text data is divided into scenes and these scenes are compared against various values across the database scenes from different texts. Data from one text can be used to identify other texts with similar or different styles and the differences are ranked on a spectrum. The system may use data from one text to identify other texts that a user may like, and present information about the text to the user in various forms. While the present disclosure provides a method and system for analyzing elements of text for comparative purposes, it lacks grammatical parsing technology.

A last prior art worth mentioning is the form of US Patent Publication No. 20110270607 issued to Zuev, Konstantin which inter alia discloses a method and system for semantic searching of natural language texts. The said method inter alia includes automatic analyzing of at least one corpus of natural language text; performing a syntactic analysis; building a semantic structure for the sentence; associating each generated syntactic analysis using linguistic descriptions; building a semantic structure for the sentence; associating each generated syntactic and semantic structure with the sentence; saving each generated syntactic and semantic structure; performing an indexing operation to index lexical meaning and values of linguistic parameters; and searching in at least one preliminary analyzed corpus for sentences comprising a searched value for at least one linguistic parameter. The present disclosure provides a method and system for an automated analysis of at least one corpus of natural language text is disclosed. However, the prior art does not mention about the process of determining the Agents, Topic or Objects from the corpora of text as well as method to visually present the same. Moreover, the system does not offer a grammatical technology for parsing above-mentioned components in a given text.

In all relevant prior arts discussed above, there is a general disregard for grammatical parsing and search while sentence-level and cross-sentence correlations among grammatical categories of texts. Various examples of grammatical search include Agent, Topic, Object, Gender, Noun, Case, Tense and the like. There exists a need, therefore, for an improved system and method of discourse analysis that incorporates targeted grammatical search within texts for the purpose of finding particular information with regards to grammatical components of a sentence. Such system and method in a way informs, for instance, who think/says what about which objects/subjects in the given text and across texts. In the development of this invention, NLP (Natural Language Processing) technologies and methodologies have played substantial and significant roles. NLP is the computerized approach to analyze text that is based on both a set of theories and a set of technologies. NLP is considered a discipline within the technical domain and intellectual traditions of computer science, artificial intelligence, and linguistics concerned with the interactions between computers and human's natural languages. The present invention can be broadly connected to the field of textual discourse analysis in linguistics and informed by other theories form the social sciences. Discourse analysis is a well-known intellectual tradition that investigates and determines the relations among language, structure and agency. Discourse analysis is a major concept in the fields of linguistics, sociology, anthropology, literary theory, and the philosophy of science. Discourse analysis is often defined as a knot of contradictions of competing concepts, practices or traditions that are in interplay among various agents in a particular text. Moreover, discourses inform internal relations among various agents and concepts and among discourse or inter-discourse because a discourse does not exist in isolation. Discourse analysis in its modern form came to be understood as a methodology for uncovering positions of various agents in relation to a particular issue from a given textual source.

The present invention as disclosed herein is a textual discourse analysis to analyze and visualize functions of concepts, both logical and axiological oppositions. The present textual discourse analysis provides a novel approach for automatically classifying the position of Agent/s within a particular text with regard to Topics, and Objects. Agent/s, Topic/s and Object/s, as defined in this invention, are similar to tripartite structures of a sentence, nevertheless with many modifications. The tripartite structures have been defined variously and differ in terms of functions and roles each set play in a sentence. In this invention, after parsing the given sentence using dependency grammar, decision trees are extracted from within rule applications for creating relational triplets. After processing the resulting dependency tree, there basic grammatical components, namely Agent/s, Topic/s, and Object/s are isolated and classified. A computer program method of the present invention starts by creating a conceptual map of a given text, classifying semantic macro-areas, positions of agents. In the next step of the invention, the computer assigns a reference system, provided for analyzing denotative content of discourse. The system is based upon a database of terms of words and phrases and their associated denotative as well as connotative meanings. The system deciphers grammatical relations among sentence components and organizes information from within and across sentences. From the generated results, the program creates a database, axiologically categorizing subject-matters within a given text or across and among unrelated texts. In the later steps, the present invention discloses a discoursive map of the positions of Agent/s in a given text vis-à-vis particular Topic/s and Object's using discourse analysis methodology. From the vast pool of data, this discursive analytics methodology gives users the capability to automatically generate accurate analysis of a given text to aid in the selection and categorization of agents and contested subjects of analysis. The present invention serves several objects, which are explained in the ensuing paragraphs.

### OBJECT OF THE INVENTION

It is therefore an object of the invention to provide a system and method for automatically classifying text using discourse analysis to analyze and visualize functions of concepts, both logical and axiological relations.

It is therefore an object of the invention to provide a system and method for automatically classifying text using discourse analysis for automatically classifying the position of agent/s within a particular text with regard to an object, subject or concept.

It is therefore an object of the invention to provide a system and method for automatically classifying text using discourse analysis wherein a database of terms of words and phrases are used along with their associated denotative as well as connotative meanings.

Another object of the present invention is to provide a system and method for automatically classifying text, which is conceived to be a sequence of computer-executed steps leading to reorganization of sentences, paragraphs and larger text, reconnecting them based on grammatical components.

### SUMMARY OF THE INVENTION

An embodiment of the invention discloses a method for automatically classifying the position of Agent/s within a particular text including receiving a text query having at least one Agent, Topic and/or Object; creating a conceptual map of the text query for visually representing the interrelated portions of the text; classifying a plurality of semantic macro-areas related to the received text input; determining the position of the agents in the received text query; assigning a reference system for analyzing denotative content of discourse; generating a database for axiologically categorizing subject-matter of the text input; and creating a visual representation of positions and interrelations related to the received text input.

Yet another embodiment of the invention discloses a system for automatically classifying the position of Agent/s within a particular text comprising a computer system including a microcontroller bus coupled with a processor, a main memory, a display controller, a special-purpose logic unit, and a communication interface and a display device; wherein a user inputs the search text query through the communication interface. The said communication interface is coupled with the microcontroller bus to provide a two-way communication through a network link connected to a communication network and the information so received by the communication interface is parsed to the processing unit for further processing. The said processing unit through the special-purpose logic units performs special processing functions and the information so received is stored into a storage device in the form of a classified text. The said classified text is displayed on the display device.

As discourse analytics is a method of evaluating positions of Agents in a given text vis-à-vis particular Topics, and Objects, the invention's main contribution is to easily and effectively organize information about particular discourses. Textual sources in digital form are pervasive, especially on the Internet where easy access has made it possible for everyone to retrieve vast amount of textual data with click of a search button. From the vast pool of data, discourse analytics gives users the capability to automatically generate accurate analysis of a given text to aid in the selection and categorization of agents and contested subjects of analysis. Automatic segmentation of text is then accomplished by statistical methods and by shallow and deep parsing techniques. In addition to shallow parsing, sentences are also syntactically parsed in order to tag internal structure or the role of each word in a particular sentence. The machine uses statistical methods of segmentation for tagging words and creating lists of tagged words into structures. The program uses the information gathered on linguistic structures on sentences, clauses and phrases to produce detailed analytics on the relations among contents.

Other objects and advantages of the embodiments herein will become readily apparent from the following detailed description taken in conjunction with the accompanying drawings.

### BRIEF DESCRIPTION OF THE INVENTION

This invention allows for the possibility of discursive grammatical search inside and across sentences, paragraphs and larger documents. The software first marks relevant grammatical components in the dependency tree. Then, entity and part of speech are applied to parse a sentences grammatically in order assign the words to semantic information. Semantic information can be used to map the extracted triplets in a set of relations, named Agent, Topic and Object. The system identifies relations between these three grammatical components in order to map sentence-level and document level discursive relations of Agent/s in documents. Figures below illustrate these processes.

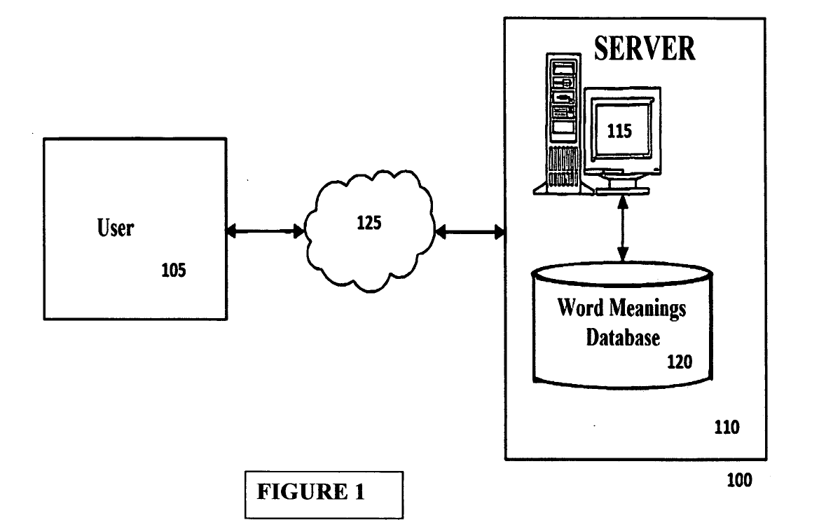

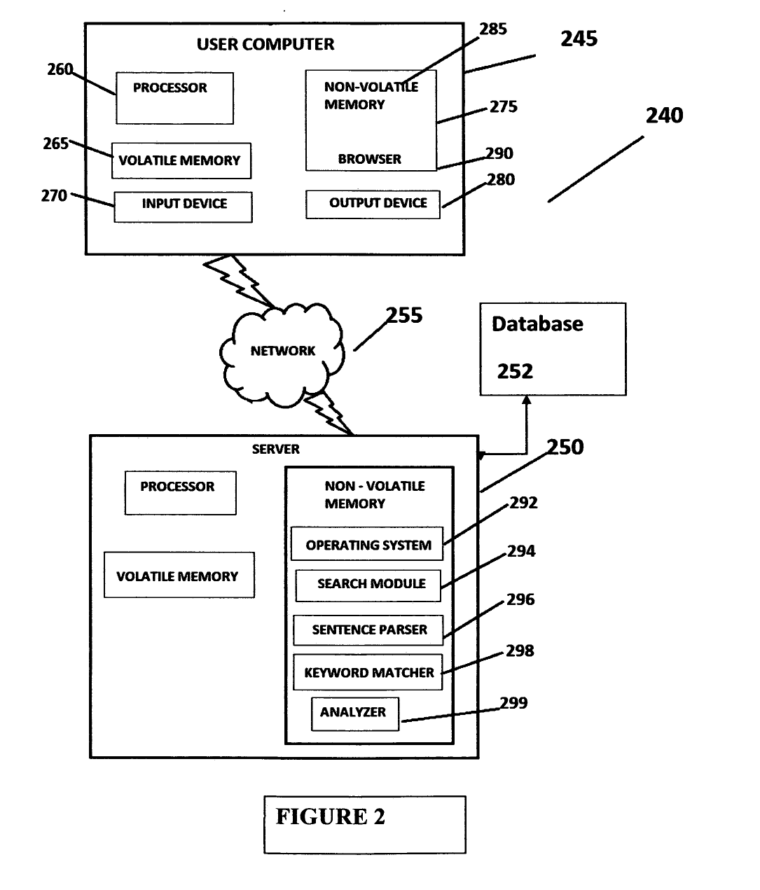

FIG. 1 illustrates an example. It illustrates the method for automatically classifying the position of grammatical categories within a particular text in an embodiment of the invention.

FIG. 2 illustrates an example of how the performs the method for automatically classifying the position of grammatical categories.

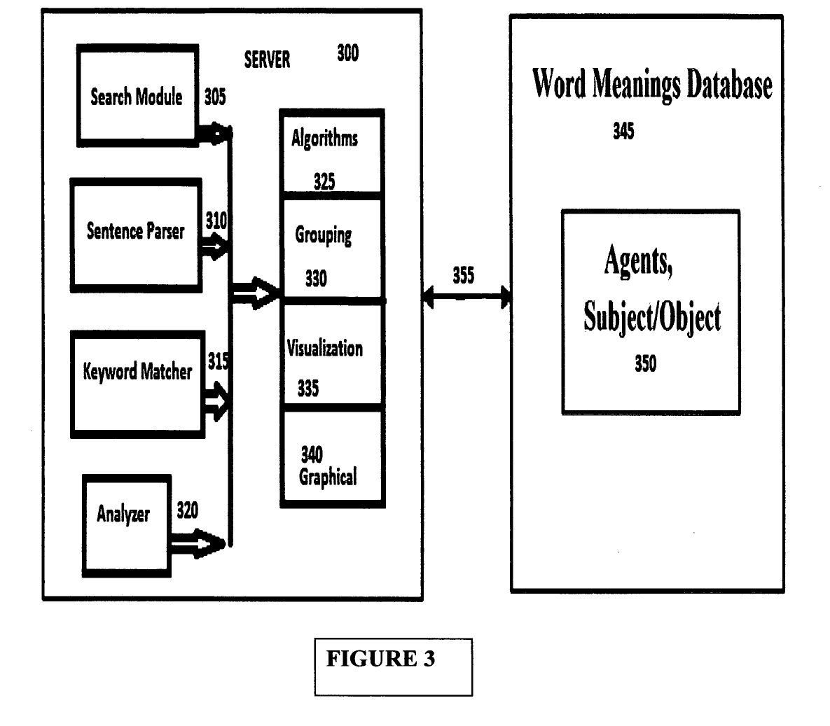

FIG. 3 illustrates interaction between a server and a database of an embodiment of the present invention.

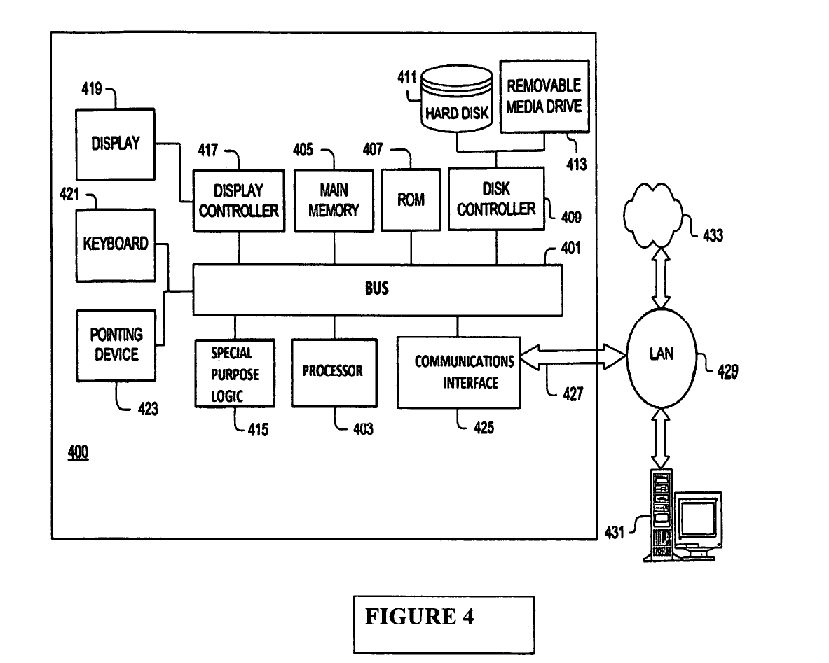

FIG. 4 of the present invention discloses another example of embodiment of the present invention.

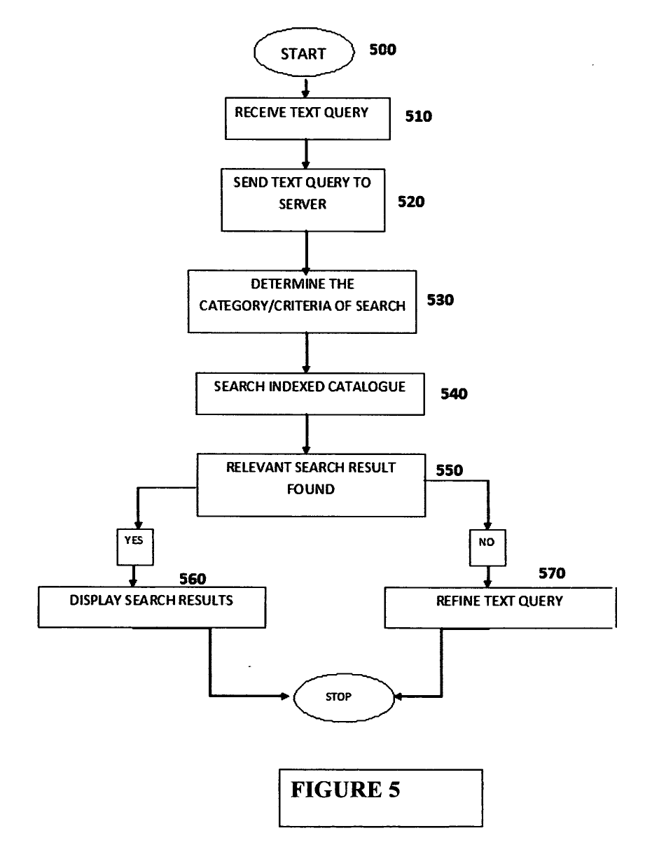

FIG. 5 discloses a flow process of analyzing the keywords and segregating them into various grammatical categories of another embodiment of the present invention.

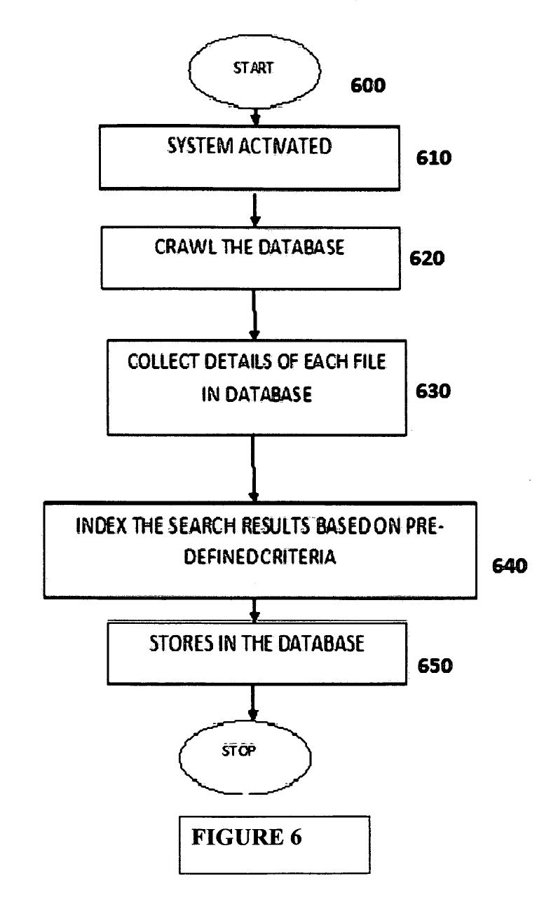

FIG. 6 discloses a flow process of preparing the indexed catalog in the server.

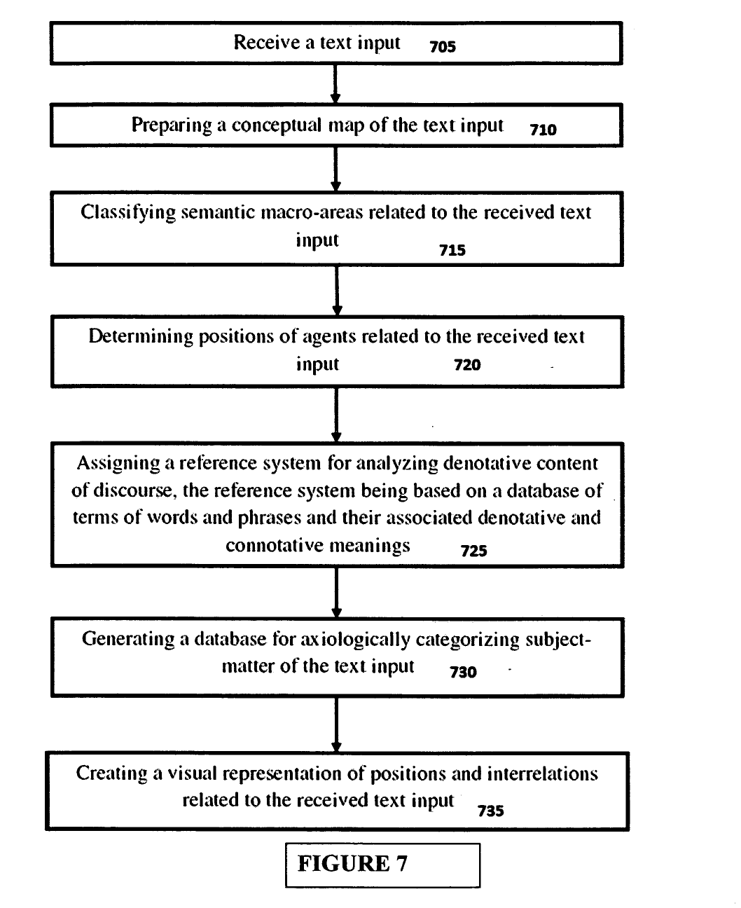

FIG. 7 illustrates a flowchart depicting steps of execution of text query in a system for automatically classifying the position of grammatical categories within a particular text in an embodiment of the invention.

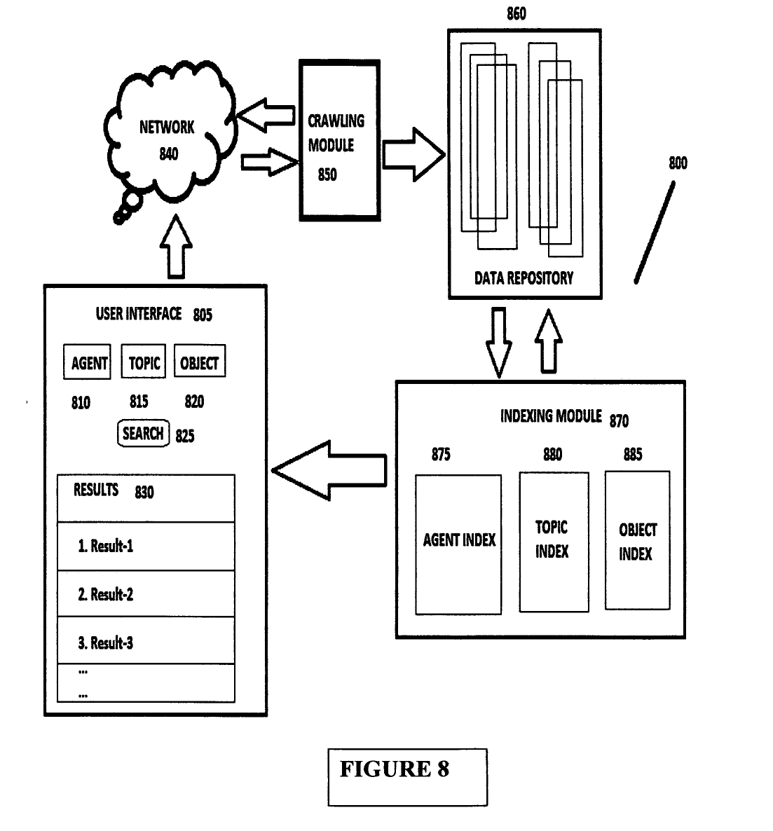

FIG. 8 discloses a block diagram of an embodiment of the system configured to perform the method for automatically classifying the position of grammatical categories.

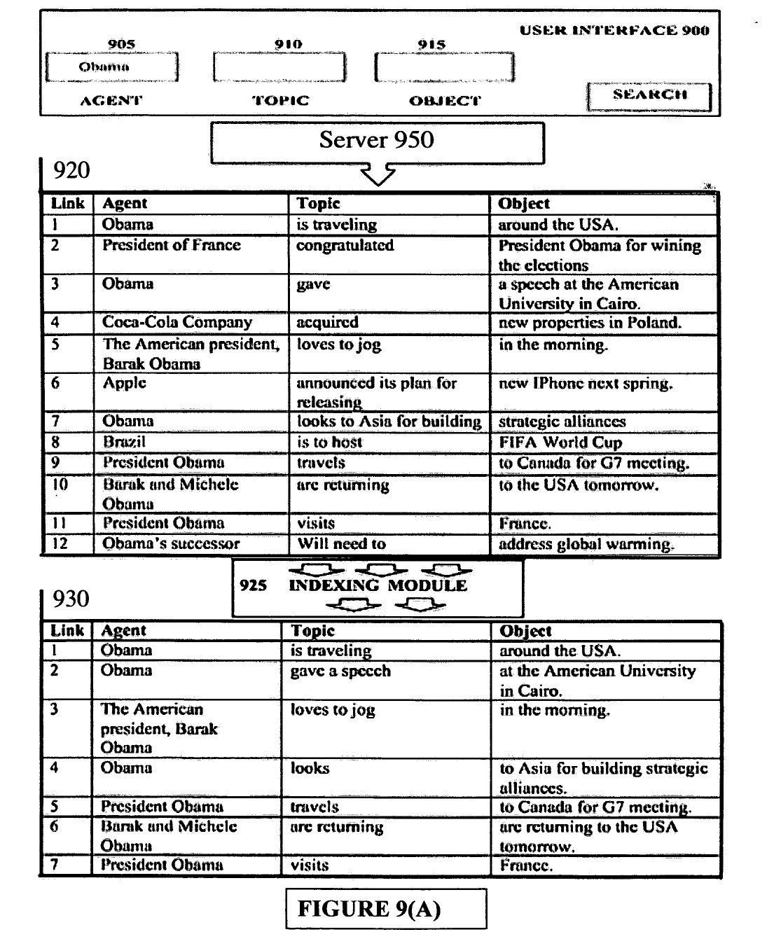

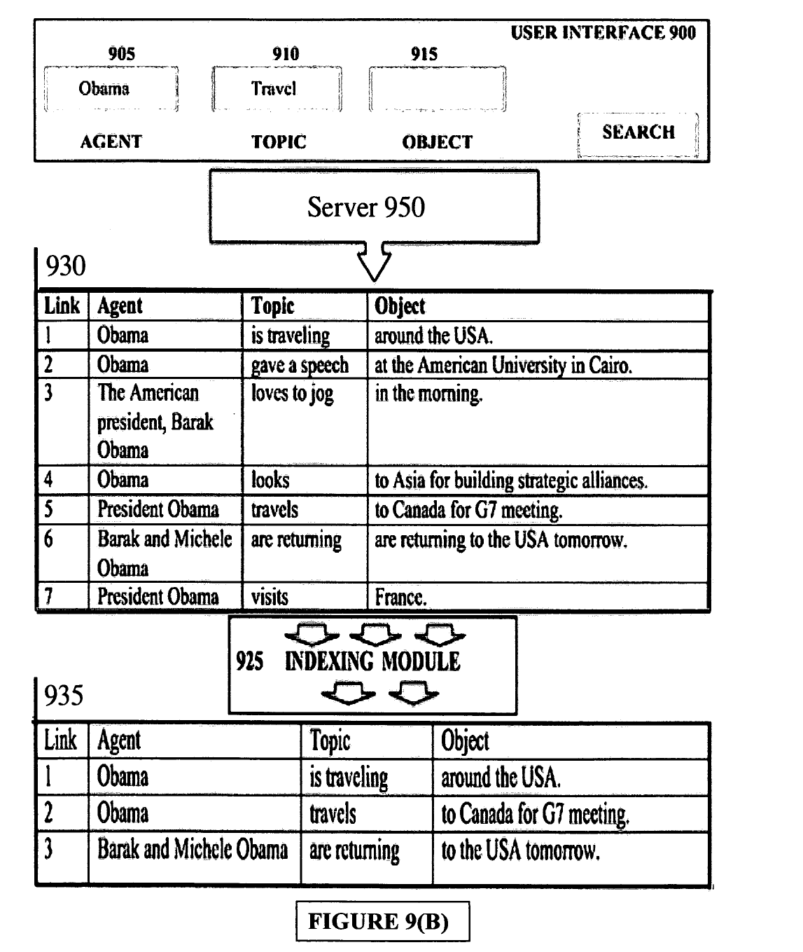

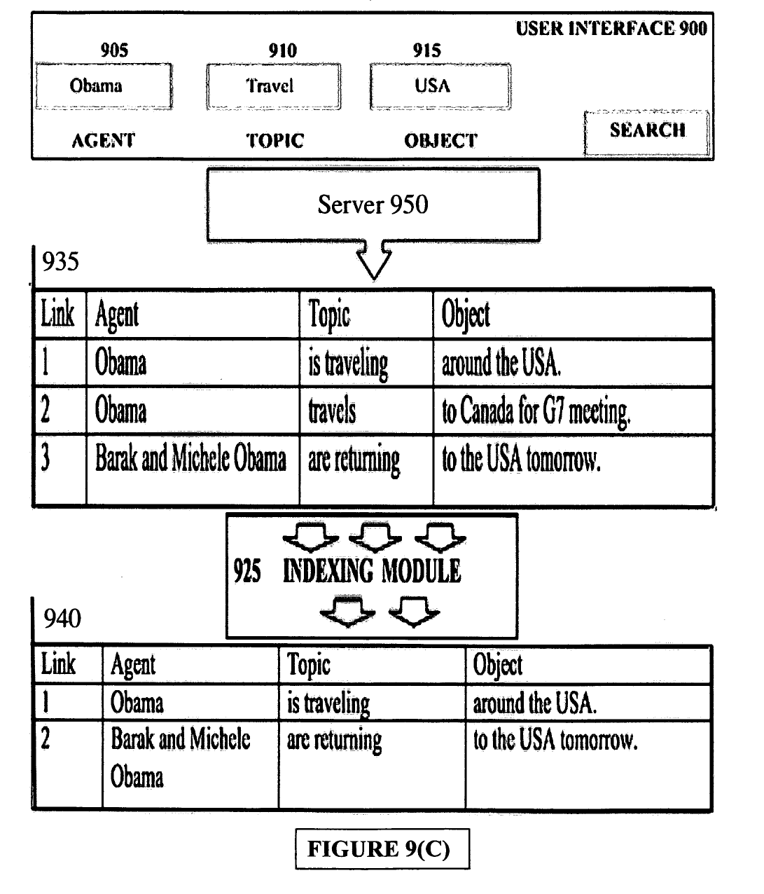

FIGS. 9 (A), 9 (B) and 9 (C) discloses various illustrations of an embodiment of a system configured to perform the method for parsing the grammatical information within sentences.

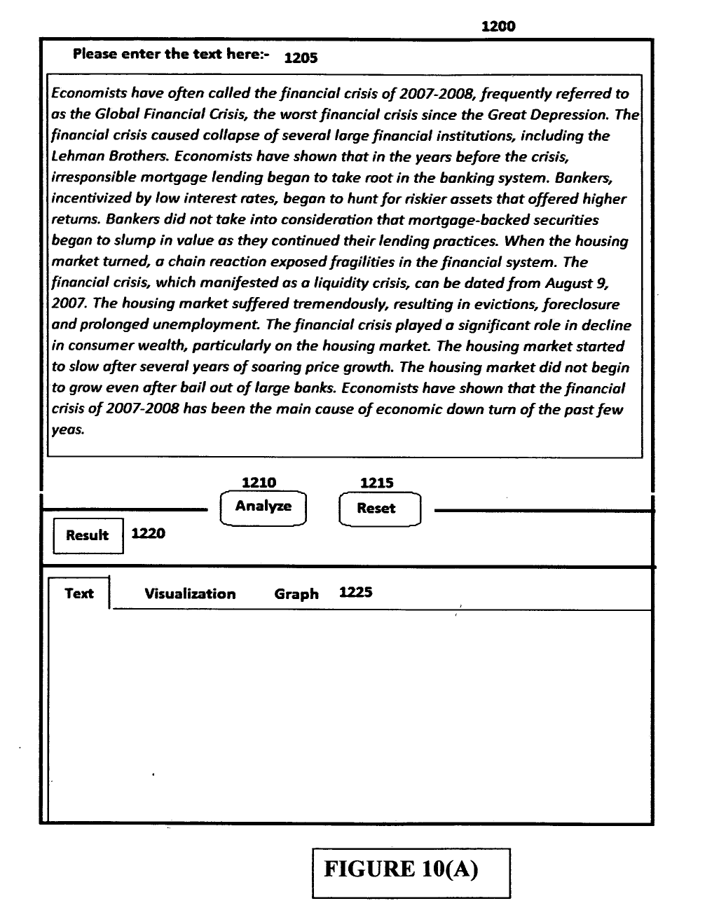

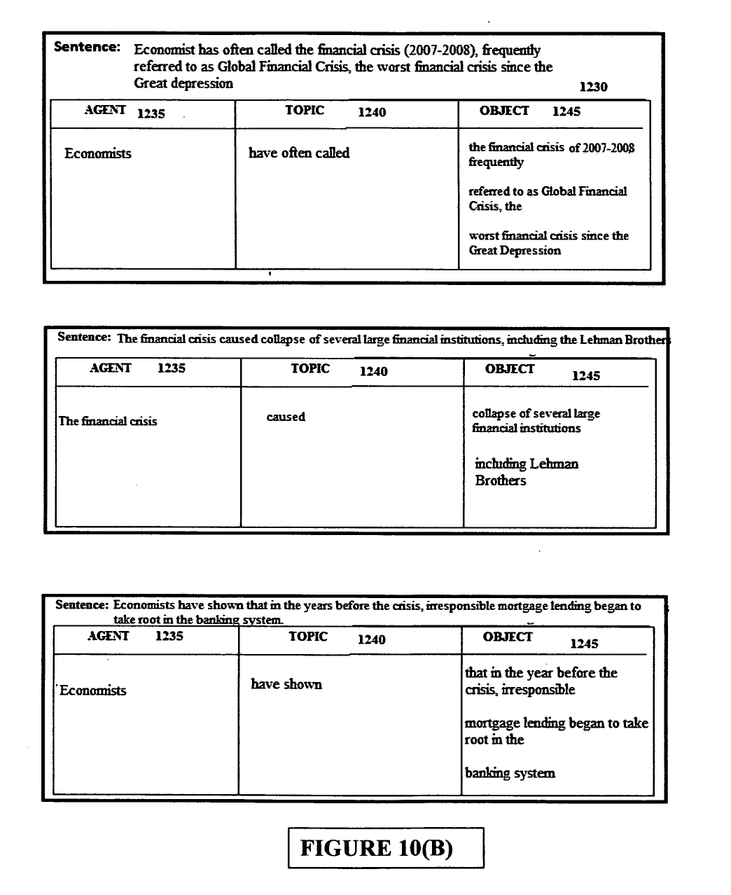

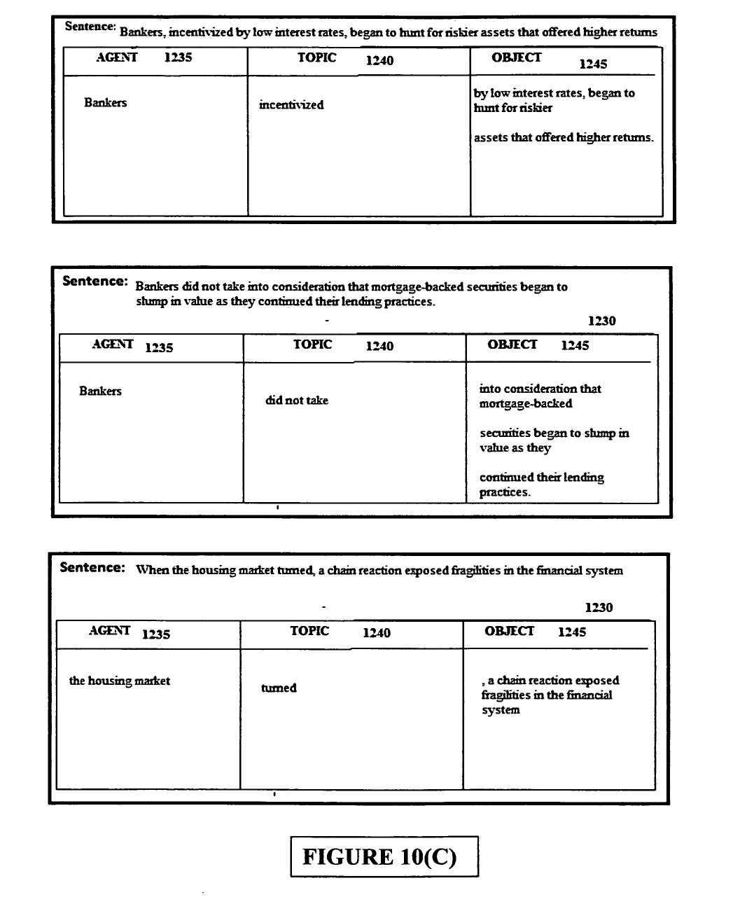

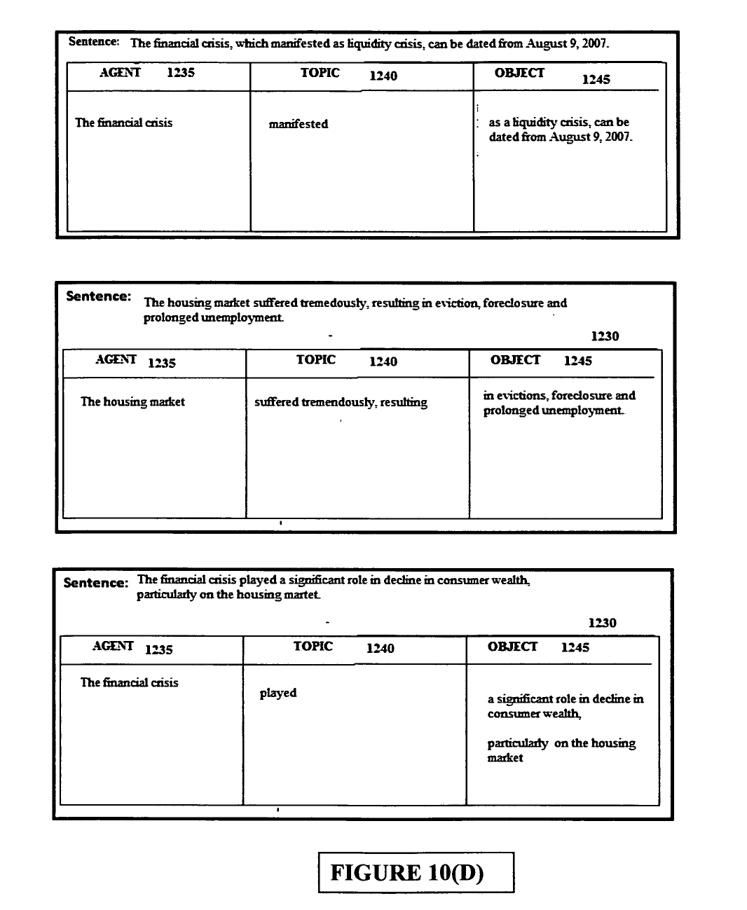

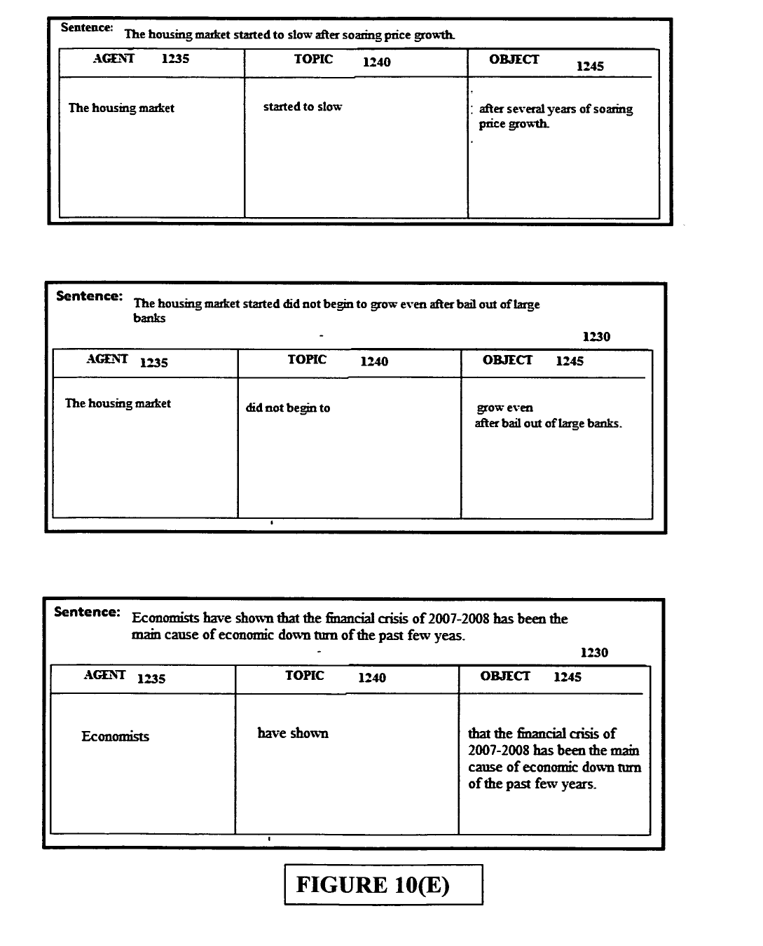

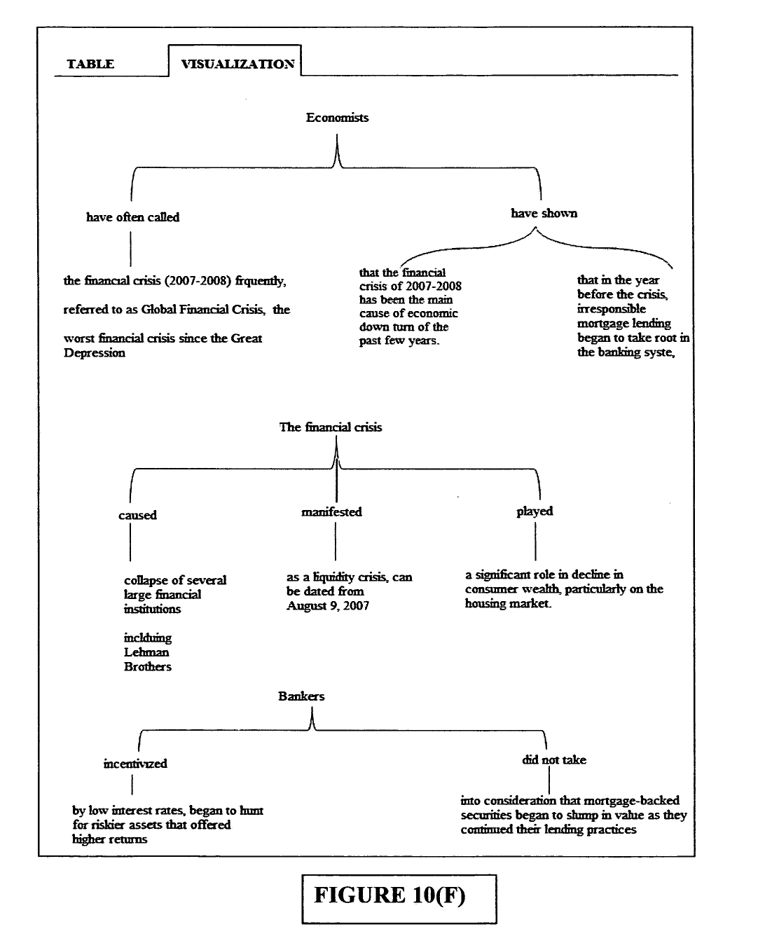

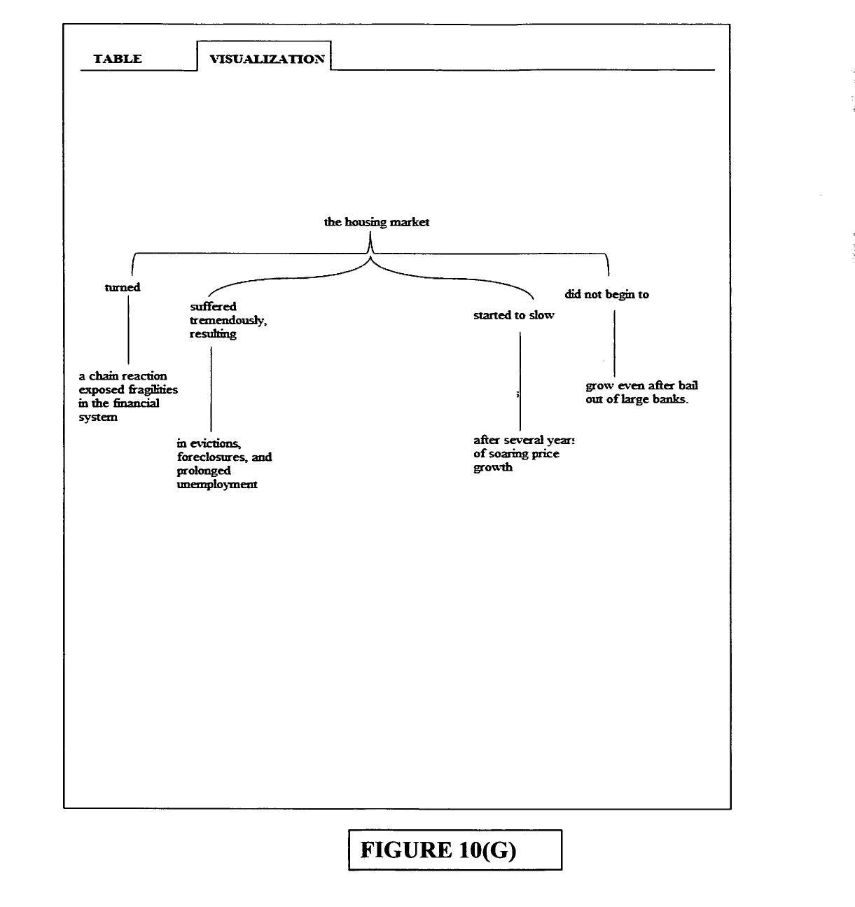

FIGS. 10(A), 10(B), 10(C), 10(D), 10 (E), 10 (F) and 10 (G) discusses an embodiment of the present invention illustrating parsing of grammatical information across sentences of larger text.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The detailed description as discussed and disclosed herein is largely represented in terms of processes, symbolic representations or visualizations of operation performed by conventional computer components including without limitation a central processing unit (CPU), memory storage devices, connected pixel-oriented display devices and the like. These operations include the manipulation of data bits by the CPU, and the maintenance of these bits within data structures residing in one or more of the memory storage devices. Such data structures are stored in the form of collection of data bits within memory storage devices and are represented by specific electrical or magnetic elements. These symbolic representations are the means used by those skilled in the art of computer programming and computer construction to most effectively convey teachings and discoveries to others skilled in the art. Although the invention discloses uses of existing hardware and systems known in the art, however, in any event use of any future technology for implementation of invention shall not be construed as limitation to the present invention.

For the purposes of the present invention, a process is generally conceived to be a sequence of computer-executed steps leading to a desired result. These steps generally require physical manipulations of physical quantities. Usually, although not necessarily, these methods take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc., which are often associated with manual operations performed by a human operator. It must be understood that no such involvement of a human operator is necessary or even desirable in the present invention. The operations described herein are machine operations performed in conjunction with a human operator or user who interacts with the computer. The machines used for performing the operation of the present invention include general purpose digital computers or other similar computing devices. In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

Reference in this specification to “one embodiment” or “an implementation” means that a particular feature, structure, or characteristic described in connection with the embodiment is included in at least one implementation of the invention. The appearances of the phrase “in one embodiment” or “in one implementation” in various places in the specification are not necessarily all referring to the same embodiment or implementation, nor are separate or alternative embodiments mutually exclusive of other embodiments. Moreover, various features are described which may be exhibited by some embodiments and not by others. Similarly, various requirements are described which may be requirements for some embodiments but not other embodiments.

FIG. 1 illustrates an example of how the system automatically classifies the position of grammatical categories including without limitation, Agent, Topic, and Object within a particular text in an embodiment of the invention. The said system (100) may include at least one user (105) connected to a server (110) through a communications network (125). The server (110) can be located locally or globally. The server (110) has a module for automatic classification (115) residing in it. The user (105) keys-in a text query using a keyboard (not shown) and a graphical user interface (not shown), which is forwarded to the server (110) through the communication network (125), which can be wired or wireless. The text query can be a single word or a plurality sentence containing letters, words, special characters, numerals or a combination thereof.

The module for automatic classification (115) residing on the server (110) activates on receipt of the text query. It automatically classifies the Agent, Topic and Object in the text query and prepares a conceptual map of the same with the aid of a database (120). The said database (120) can be a local database residing on a specific drive of the server or it can be a database fetching its data from the World Wide Web. At the time of keying-in the text query, the user prescribes the format of search result i.e. textual, visual, graphical and the like. Based on the format of search result, the module prepares the search results and displays the same on the graphical user interface for user's consumption. The search results so received by the user are accurate since, the module does not simply tags the relevant words rather, it identifies its grammatical category i.e. Agent, Topic and Object as they interrelate to others within and across sentences and based on its kind traces out the most accurate the relevant search results.

FIG. 2 illustrates an example of how the invention automatically classifies the position of grammatical categories. The said system (240) comprising a user computer (245) connected to a server (250) through a network (255) and a database (252).

The user computer (245) comprising a processor (260), a volatile memory (285), an input (270) device, an output (280) device and a non-volatile memory. The processor (260) is capable of executing computer language instructions, code, programs codified to achieve a specific purpose. The processor can process several computer executable programs together to accomplish a specific task. The volatile memory (265) is capable of storing the text query, data, information etc. keyed-in by the user. A few of the examples of volatile memory (265) includes without limitation Random Access Memory (RAM), Static RAM, Dynamic RAM and the like. The user keys-in the text query using an input (270) and an output device (280). Any information or data that's entered or sent to the server (250) to be processed is considered input and anything that is displayed from the server (250) is output. Therefore, an input device such as, a computer keyboard, mouse, scanner, microphone, stylus and the like, are capable of having information sent to the computer, but does not display (output) any information. An output device such as a display screen, printer, disk, drives, flash drives and the line, which can display any information received from the server (250). The text query, information so received from the user is forwarded to the server (250), which is also stored in the non volatile memory (285). An illustration of a non-volatile memory may include Read Only Memory (ROM), flash memory, several kind of magnetic storage device and the like. If the server (250) is located remotely, the system (240) facilitates the user to access the same through a browser (290) residing and being operated through the non-volatile memory (285).

The text query so received from the user computer (245) is forwarded to the server (250) through a network (255), which can be wired or wireless. The server (250) can have a processor, a volatile memory and a non-volatile memory. The server (250) has an operating system (292), a search module (294), a sentence parser (296), a keyword matcher (298) and an analyzer (299). The modules mentioned herein are strictly for illustration purpose and the same can be increased or decreased depending upon the complexity of the data involved as well as number of users using the said system (240).

The text query is processed using a processor (260). The server (250) being operated and managed through the operating system (292). The text query passes through the search module (294), which identifies the relevant key words of the text query and forwards the same to the sentence parser (296). The sentence parser (296) grammatically parses the text query and the keyword into different grammatical categories. These parsed keywords are processed through the keyword matcher (298), which identifies similar keywords in the search results residing in a database (252). The analyzer (299) analyzes the relevant search results and picks-up only those results wherein the keywords, which were searched, are present in the same searched grammatical category.

The functioning of an embodiment of the system (240) is explained by way of an illustration, the same should not be construed as the limitation of the invention. A user keys-in the query “Obama travels” into the system (240). After receiving the query, the system (240), forwards the said text query to the server (250) through the operating system (292). In the server (250), the search module (294) gets activated and identifies the keyword along with its category i.e. it identifies the keyword “Obama” and “travels” and forwards these keywords to sentence parser (296). The sentence parser (296) parses these keywords into their relevant grammatical categories. i.e. keyword “Obama” as the Agent, keyword “travels” as the Topic (details of each of these functions are explained below). After identification of the keywords and its category, the parsed keywords along with its categories are forwarded to keyword matcher (298). The function of keyword matcher (298) is to identify all those relevant results, wherein these keywords exist. Assuming the keyword matcher (298) identifies sentences from the database (252).

The sentences identified by grammatical categories are finally forwarded to analyzer (299), which analyzes the search results and displays of sentences and final results are stored in the database as result. The major advantage associated with the system (240) is its capability to parse, match and analyze the most relevant result based on the categories and present the most relevant result. After general description of the invention cases examples will be provided for better understanding of the system.

FIG. 3 illustrates an exemplary block diagram explaining the interaction between a server (300) and a database (345) of an embodiment of the present invention. The said illustration attempts to elaborate the functional interaction between the server (300) and the database (345) in a system. The server (300) is connected to the database (345) through a communication network (355). The said server (300) has various modules residing in it, which performs various functionalities over a text query through various pre-codified algorithms to provide desired search results. Various modules include without limitation a search module (305), a sentence parser (310) a keyword matcher (315) and an analyzer (320). The number of modules may increase or decrease depending upon the complexity of the system as well as number of users. The various modules discussed above contain several algorithms (325) to include without limitation grouping algorithm (330), visualization algorithm (335) graphical algorithm (340) and the like.

The various modules residing over the said server (300) performs its functionalities with aid and assistance of the database (345) connected through a communication network (355). Any text query keyed-in by the user is bifurcated into Agent, Topic and Object through various modules and the relevant search results of the same are traced using the database (345). The database (345) aids in identifying various denotative and connotative meanings of the search terms, its inter-relationship with agents, subjects or topics and the like. Various modules and server in the present embodiment of the invention are capable of employing natural language processing for the purpose of text analysis, semantic tagging, analyzing denotative content etc.

FIG. 4 of the present invention discloses another exemplary embodiment of the present invention. The said embodiment includes a computer system (400) upon which the devices and subsystems can be implemented. The computer system (400) as disclosed herein can be a single such computer system or a collection of multiple computer systems connected together through wired or wireless network. The said computer system (400) includes a microcontroller bus (401), which is coupled with a processor (403), main memory (405), a display controller, (417), a special-purpose logic unit (415), a disc controller (409) and a communication interface (425).

The information so collected through the communication interface (425) is processed by the processor (403) and stored into the main memory (405). The said main memory (405) can be a Random Access Memory (RAM) or any other dynamic storage device i.e. to mean and include dynamic RAM (DRAM), static RAM (SRAM), synchronous DRAM (SDRAM) and the like. The primary function of the main memory as well as other dynamic storage devices is to store the information and instructions to be executed by the processor while processing the information as well as storing temporary variables or other intermediate information during the execution of instructions by the processor. The computer system (400) may also include static storage device coupled with the microcontroller bus for storing static information and instruction. The static storage device may include without limitation Read Only Memory (ROM), programmable ROM (PROM), erasable PROM (EPROM), and electrically erasable PROM (EEPROM). A detachable storage device such as a magnetic hard disk (411), a removable media drive (413) (e.g. without limitation, floppy disk drive, read-only compact disc drive, read/write compact disc drive, compact disc jukebox, tape drive, removable magneto-optical drive, flash drive, such as thumb drive, pen drive, and the like) can be connected to the computer system (400) using an appropriate device interface i.e. small computer system interface (SCSI), integrated device electronics (IDE), enhanced-IDE (E-IDE), direct memory access (DMA), or ultra-DMA) for the purpose of storing information and instructions. The special purpose logic devices (415) so connected with the computer system (400) can perform special processing functions, such as signal processing, image processing, speech processing, optical character recognition (OCR), voice recognition, text-to-speech and speech-to-text processing, communications functions, genetic algorithm functions, weighting functions, number language functions, class/category structure functions, and the like. A few of the examples of special purpose logic devices (415) are specific integrated circuits (ASICs), fill custom chips, configurable logic devices, e.g., simple programmable logic devices (SPLDs), complex programmable logic devices (CPLDs), field programmable gate arrays (FPGAs), and the like.

The display controller (417) coupled with the microcontroller bus (401) controls the display device (419) such as, without limitation, a cathode ray tube (CRT), liquid crystal display (LCD), television display, active matrix display, plasma display, touch display, and the like, for displaying or conveying information to a computer user. The computer system (400) can be aided through various input devices such as, without limitation a keyboard (421) including alphanumeric and other keys and a pointing device (423) for interacting with a computer user and providing information to the processor (403). The pointing device (423) can include, for example, a mouse, a trackball, a pointing stick, etc. or voice recognition processor, etc., for communicating direction information and command selections to the processor (403) and for controlling cursor movement on the display (419). In addition, a printer can provide printed listings of the data structures/information.

The computer system (400) can perform all or a portion of the processing steps of the invention in response to the processor (403) executing one or more sequences of one or more instructions contained in a memory, such as the main memory (405). Such instructions can be read into the main memory (405) from another computer readable medium, such as the hard disk (411) or the removable media drive (413). Execution of the arrangement of instructions contained in the main memory (405) causes the processor (403) to perform the process steps described herein. One or more processors in a multi-processing arrangement also can be employed to execute the sequences of instructions contained in the main memory (405). In alternative embodiments, hard-wired circuitry can be used in place of or in combination with software instructions. Thus, embodiments are not limited to any specific combination of hardware circuitry and/or software.

The computer system (400) can also include a communication interface (425) coupled to the microcontroller bus (401). The communication interface (425) can provide a two-way data communication coupling to a network link (427), which is connected to a communication network. The examples of communication network (433) may include a Local Area Network (LAN) (429), a wide area network (WAN), and a global packet data communication network, such as the Internet. As a matter of illustration, the communication interface (425) can include a digital subscriber line (DSL) card or modem, an integrated services digital network (ISDN) card, a cable modem, a telephone modem, and the like to provide a data communication connection to another communication line. As another example, the communication interface (425) can include a local area network (LAN) card (e.g., for Ethernet™, an Asynchronous Transfer Model (ATM) network, and the like), to provide a data communication connection to a compatible LAN. Wireless links can also be implemented. In any such implementation, the communication interface (425) can send and receive electrical, electromagnetic, or optical signals that carry digital data streams representing various types of information. Further, the communication interface (425) can include peripheral interface devices, such as a Universal Serial Bus (USB) interface, a PCMCIA (Personal Computer Memory Card International Association) interface, etc. The network link (427) typically can provide data communication through one or more networks to other data devices. For example, the network link (427) can provide a connection through the LAN (429) to a host computer (431), which has connectivity to the network (433) or to data equipment operated by a service provider. The LAN (429) and the network (433) both can employ electrical, electromagnetic, or optical signals to convey information and instructions. The signals through the various networks and the signals on the network link (427) and through the communication interface (425), which communicate digital data with computer system (400), are exemplary forms of carrier waves bearing the information and instructions.

The computer system (400) can send messages and receive data, including program code, through the network (429) and/or (433), the network link (427), and the communication interface (425). In the Internet example, a server can transmit requested code belonging to an application program for implementing an embodiment of the present invention through the network (433), the LAN (429) and the communication interface (425). The processor (403) can execute the transmitted code while being received and/or store the code in the storage devices (411) or (413), or other non-volatile storage for later execution. In this manner, computer system (400) can obtain application code in the form of a carrier wave.

With the system of FIG. 4, the embodiments of the present invention can be implemented on the Internet as a Web Server (400) performing one or more of the processes according to the embodiments of the present invention for one or more computers coupled to the Web server (400) through the network (433) coupled to the network link (427). The term computer readable medium as used herein can refer to any medium that participates in providing instructions to the processor (403) for execution.

Such a medium can take many forms, including but not limited to, non-volatile media, volatile media, transmission media, etc. Non-volatile media can include, for example, flash drives, optical or magnetic disks, magneto-optical disks, etc., such as the hard disk (411) or the removable media drive (413). Volatile media can include dynamic memory, etc., such as the main memory (405). Transmission media can include coaxial cables, copper wire and fiber optics, including the wires that make up the bus (401).

Transmission media also can take the form of acoustic, optical, or electromagnetic waves, such as those generated during radio frequency (RF) and infrared (IR) data communications. As stated above, the computer system (400) can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, flash drive, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read. Various forms of computer-readable media can be involved in providing instructions to a processor for execution. For example, the instructions for carrying out at least part of the embodiments of the present invention can initially be borne on a magnetic disk of a remote computer connected to either of the networks (429) and (433). In such a scenario, the remote computer can load the instructions into main memory and send the instructions, for example, over a telephone line using a modem. A modem of a local computer system can receive the data on the telephone line and use an infrared transmitter to convert the data to an infrared signal and transmit the infrared signal to a portable computing device, such as a PDA, a laptop, an Internet appliance, etc. An infrared detector on the portable computing device can receive the information and instructions borne by the infrared signal and place the data on a bus. The bus can convey the data to main memory, from which a processor retrieves and executes the instructions. The instructions received by main memory can optionally be stored on storage device either before or after execution by processor.

Stored on any one or on a combination of computer readable media, the embodiments of the present invention can include software for controlling the computer system (400), for driving a device or devices for implementing the invention, and for enabling the computer system (400) to interact with a human user e.g., users of the exemplary embodiments of FIGS. 1-3 and the like. Such software can include, but is not limited to, device drivers, firmware, operating systems, development tools, applications software, etc. Such computer readable media further can include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, and dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

FIG. 5 discloses a flow process of analyzing the keywords and segregating them into various grammatical categories. As illustrated, the process triggers (500) immediately after receipt of the text query (510). The system forwards the text query to a server (520), which ultimately processes the text query by determining the search criteria and grammatical categories (530), wherein the text query can be searched. After determination of the specific search criteria and grammatical categories, the system indexes the keywords of text query and catalogues them (540) based on grammatical categories. The indexed catalogue is prepared by the system after traversing all the data, information pertaining to the specific grammatical category residing into the database. The index catalogue includes catalogue of keywords acting as Agent/s, keywords acting as Topic/s, and keywords acting as Object/s. The system is capable of generating multiple indexed catalogs depending upon various grammatical categories.

Then, the system searches the keyword in the specific indexed catalogue and if the same exist, the system displays the results (560) or remands the text query for further refinement (570). The system is designed and developed in such a fashion that it is capable of handling a single keyword or several keywords.

FIG. 6 discloses a flow process of preparing the indexed catalog. The system starts (600) and the server in the system gets activated (610). The server has a crawling module, which is capable of sending crawlers on each data, information residing on the database (620), which collects relevant information (630). The relevant information collected by the crawler is analyzed and bifurcated into pre-defined grammatical categories i.e. Agent, Topic, and Object (640). After bifurcation, the data, information is stored into a database (650) for further use.

The bifurcation of the information into pre-defined categories is in such a fashion that a single sentence having combination of keywords are catalogued within categories i.e. Agent, Topic, and Object. Based on the text query, the system automatically picks up the right result from these indexed catalogs.

FIG. 7 illustrates a flowchart depicting steps of execution of text query in a system for automatically classifying the position of grammatical categories within a particular text in an embodiment of the invention.

This invention advances on classical conceptual modeling approaches such as entity-relationship or class diagrams, which are based upon the idea of reorganization or division of a sentence based on tripartite grammatical formation, namely subject-predicate-object expression. These expressions are known as triplets in various linguistic corners although, it must be noted, the division of the clause into two main parts—a subject and a predicate—structure has been accepted by most English grammar experts. In this invention, advancements are made the above mentioned tripartite system: the Agent denotes the resource or actor, and the Topic denotes an action or trait of the resource that expresses a relationship between the Agent and the Object of that action or trait. For example, one way to represent the notion “the sun is bright” in this invention is create the triplet: an Agent denoting “the sun,” a Topic incorporating predicate denoting “is,” and an Object denoting “bright.” Therefore, in this case, Agent connection Object through Topic denotes some value. The particular way in which a resource or triple is encoded varies from format to format incorporating of animate and inanimate agent, or grammatical structure of a sentence. For example, in sentence “The president gave a speech,” the Agent “the president” is performing an action or Topic “gave,” denoting an Object, “a speech.”

As illustrated in the preceding paragraphs, the system utilizes a text query as shown in block (705). The said text query can be a single or multiple words in conjunction or disjunction. The system is capable of analyzing any number of sentences as input in order to decipher the grammatical role the queried word/s play in a sentence or sentences and accordingly classifies them as Agent, Topic or Object. As shown in block (710), after receiving the text query, the system with the aid and assistance of various modules prepares a conceptual map of the text query and visually represents the results along with its inter-related relationships explained above. While creating a conceptual map, the system automatically evaluates the position of Agents, Topic and Object within each as well as across sentences. For the purpose of evaluation, a combination of statistical methods such as shallow parsing, deep parsing and the like are used. The text query can also be syntactically parsed in order to tag internal structure or the role of each word in a particular sentence. The creation of the conceptual map of the text query is followed by classification of a plurality of semantic macro-areas related to the received text query, as described in block (715). Typically, macro-structures are postulated in order to account for the “global meaning” of discourse such as it is intuitively assigned in terms of the Topic establishing the theme of and discursive relations and the interconnected Agents and Objects. Hence, based on the search query, the macro-areas referring to the global meaning of discourse are classified.

Subsequent to the said classification of semantic macro-areas, the system, as shown in block (720) determines the position of the Agents in the received text query. The positioning of the Agent/s can be determined by identifying it/their grammatical position in relations to Topic and Object in the given text query. The determination of Agent in the given text query plays a significant role in determining discourse analysis. After determining the position of the Agents, a reference system for analyzing denotative content of discourse is assigned by the computer system, a shown in block (725). The reference system is generally based on a database of terms of words and phrases and their associated denotative and connotative meanings. The database of terms of words can be updated periodically and the same remains always up to date with the inclusion of new words with their denotative and connotative meanings. Through this step of analyzing the content, the search query achieves its precision with regards to its concept, context, reference and object. This step is followed by generating the database for axiologically categorizing subject-matter/s of the text input as in block (730). Such categorization plays a significant role in generating the accurate visual representation of the inter-relationship between the Agent/s, Topic/s, Object/s. Finally, after categorizing the subject-matter of the text input, a visual representation of positions and interrelations related to the received text input is created as in block (735

FIG. 8 discloses a block diagram of an embodiment of the system configured to perform the method for automatically classifying the position of grammatical categories. The system (800) has a user interface (805) connected to a network (840), a crawling module (850), a data repository (860) and an indexing module (870). The user interface (805) has various search options i.e. search boxes to search various keywords under a specific grammatical category such as without limitation, Agent (810), Topic (815) and Object (820). Any user can key in the relevant keyword/s in a specific search boxes and the system will search (825) the relevant results under the specific grammatical category.

The crawling module (850) in the system is capable of crawling each and every data, information residing in the database and the same is indexed into a data repository (860). The crawlers are programmed to update the data repository online or after a periodic interval depending upon the type of database used i.e. local or global. The data repository (860) further indexes the data, information received from the crawling module (850) through an indexing module (870). The indexing module is capable of parsing the data information into various grammatical categories i.e. Agent (875), Topic (880), or Object (885). The indexing module (870) is designed to index a single keyword, a sentence or a complicated discourse into various grammatical categories.

The search categories as explained in the preceding paragraphs are based on tripartite grammatical system that parses Agent/s, Topic/s and Object/s, however the same can be increased or decreased depending upon the complexity of the system. The invention can be used to parse information in order to understand and organize: (1) within sentences and (2) across sentences or in larger texts.

For the purpose of illustration and to effectively explain the functionality of the system, the concept of parsing the information within sentences and across sentences or in larger texts are explained hereinafter through FIG. 9 and FIG. 10 respectively. Any variation in said illustration being obvious to a person skilled in the art should be construed as part of the invention and not as the limitation of the present invention. The purpose of choosing illustrative sentences and paragraphs that follow are only for demonstrating the field of invention.

Parsing Grammatical Information from within Sentences

FIGS. 9 (A), 9 (B) and 9 (C) discloses various illustrations of an embodiment of a system configured to perform the method for parsing the grammatical information within sentences.

FIGS. 9 (A), (B) and (C) of the invention illustrates a user interface (900), having various search boxes catering to various search categories i.e. Agent (905), Topic (910) and Object (915). A user can, depending upon the query, fill in the relevant keyword into the specific search boxes.

In the present embodiment, a very small data repository of 12 sentences is used to facilitate detailed illustration of functionality of the system of parsing grammatical information in a computer program. However, it is pertinent to note that the system is capable of performing similar functionality of parsing grammatical information using a very small data repository (as stated, data repository of 12 sentences) to a very large data repository such as Internet based universal data repository. Hence, a very small data repository of 12 sentences as illustrated in the present embodiment should not be construed as limitation of the invention.

| Link | Agent | Topic | Object |
|---|---|---|---|
| Link 1 | Obama | is traveling | around the USA. |
| Link 2 | President of | congratulated | President Obama for |
| | France | | wining the elections |
| Link 3 | Obama | gave | a speech at the |
| | | | American University |
| | | | in Cairo. |
| Link 4 | Coca-Cola | acquired | new properties in |
| | Company | | Poland. |
| Link 5 | The American | loves to jog | in the morning. |
| | president, Barak | | |
| | Obama | | |
| Link 6 | Apple | announced its | new IPhone next |
| | | plan for releasing | spring. |
| Link 7 | Obama | looks to Asia for | strategic alliances |
| | | building | |
| Link 8 | Brazil | is to host | FIFA World Cup |
| Link 9 | President Obama | travels | to Canada for G7 |
| | | | meeting. |
| Link 10 | Barak and Michele | are returning | to the USA |
| | Obama | | tomorrow. |
| Link 11 | President Obama | visits | France. |
| Link 12 | Obama's successor | will need to | address global |
| | | | warming |

As illustrated in FIG. 9 (A), a user keys-in a keyword “Obama” in the search category box “Agent” (905), while keeping the other two search boxes dedicated to search categories “Topic” (910) and “Object” (915) empty. The search in the search box “Agent” indicates the intention of the user to search only those sentences from the data repository (920), wherein the keyword “Obama” plays the role of an Agent. For ease of understanding, the search of the keyword “Obama” will take place amongst following data repository (920):

After receiving the keyword “Obama”, the system by employing pre-programmed rules, logic and routines present in the indexing module (925) browse through the data repository (920) and picks only those links, wherein the keyword “Obama” is acting as an Agent. The system provides for following search result (930):

| Link | Agent | Topic | Object |
|---|---|---|---|
| Link 1 | Obama | is traveling | around the USA. |
| Link 2 | Obama | gave a speech | at the American |
| | | | University in Cairo. |
| Link 3 | The American | loves to jog | in the morning. |
| | president, Barak | | |
| | Obama | | |
| Link 4 | Obama | looks | to Asia for building |
| | | | strategic alliances. |
| Link 5 | President Obama | travels | to Canada for G7 meeting. |
| Link 6 | Barak and Michele | are returning | are returning to the USA |
| | Obama | | tomorrow. |
| Link 7 | President Obama | visits | France. |

In addition to the search conducted in the FIG. 9(A), along with the term “Obama” in Agent search box, the user adds another term “travels” in the Topic search box in the FIG. 9 (B). The system would trace the data repository (930), wherein all the sentences with the keyword “Obama” exist to identify those sentences wherein the term “travel” acts as a Topic. The system is capable enough to pick all those sentences, wherein the word in Topic denotes or connotes to a similar meaning of travelling. For ease of understanding, the system would trace amongst the following data repository (930):—

| Link | Agent | Topic | Object |
|---|---|---|---|
| Link 1 | Obama | is traveling | around the USA. |
| Link 2 | Obama | gave a speech | at the American |
| | | | University in Cairo. |
| Link 3 | The American | loves to jog | in the morning. |
| | president, Barak | | |
| | Obama | | |
| Link 4 | Obama | looks | to Asia for building |
| | | | strategic alliances. |
| Link 5 | President Obama | travels | to Canada for G7 |
| | | | meeting. |
| Link 6 | Barak and Michele | are returning | are returning to the |
| | Obama | | USA tomorrow. |
| Link 7 | President Obama | visits | France. |

The system traces the sentences, wherein the keyword “Obama” and “travel” are acting as Agent and Topic respectively. The indexing module (925) of the system is intelligent enough to also include those sentences, wherein the grammatical connotation results in the similar search result of Obama and travel as Agent and Topic respective. The system provides for following search result (935):

| Link | Agent | Topic | Object |
|---|---|---|---|
| Link 1 | Obama | is traveling | around the USA. |
| Link 2 | Obama | travels | to Canada for G7 meeting. |
| Link 3 | Barak and Michele | are returning | to the USA tomorrow. |
| | Obama | | |

In FIG. 9(C), the user further narrows its search criteria by adding a keyword “USA” in the Object search box along with the existing search string of “Obama” and “Travel” in the Agent and Topic search box respectively. The data repository (935) for the present search includes the following links:

| Link | Agent | Topic | Object |
|---|---|---|---|
| Link 1 | Obama | is traveling | around the USA. |
| Link 2 | Obama | travels | to Canada for G7 meeting. |
| Link 3 | Barak and Michele | are returning | to the USA tomorrow. |
| | Obama | | |

In this search, the system through the indexing module (925) restricts its search to only those sentences, wherein the keyword “Obama”, “travel” and “USA” acts as Agent, Topic and Object respectively. The system after its search provides the following search results (940):

| Link | Agent | Topic | Object |
|---|---|---|---|
| Link 1 | Obama | is traveling | around the USA. |
| Link 2 | Barak and Michele | are returning | to the USA tomorrow. |
| | Obama | | |

The above stated illustration performs the functionality of paring grammatical information using a very small data repository of 12 sentences, however, the same functionality can be performed by the system with a data repository of millions of sentences such as Internet based real-time data repository. Further, the system is capable enough to expand the area of targeted grammatical search, such as without limitation looking for patterns across the sentences, which can facilitate parsing of grammatical information from the discoursive analyses of sentences.

Parsing Grammatical Information from Across Sentences of Larger Text

FIGS. 10(A), 10(B), 10(C), 10(D), 10 (E), 10 (F) and 10 (G) discusses an embodiment of the present invention illustrating parsing of grammatical information across sentences of larger text. The illustration as shown below aims to illustrate the way in which the discoursive search operates in the present invention by taking information from across sentences and incorporating them within a unified system of discourse analytics.

The system deciphers grammatical relations among sentence components and organized information from within and across sentences. From the generated results, the program creates a database, axiologically categorizing subject-matters within a given text or across and among unrelated texts. In the later steps, the present invention discloses a discoursive map of the positions of Agent/s in a given text vis-à-vis particular Topic/s and Object/s using discourse analysis methodology. From the vast pool of data, this discursive analytics methodology gives users the capability to automatically generate accurate analysis of a given text to aid in the selection and categorization of agents and contested subjects of analysis.

FIG. 10 (A) depicts a screen shot, wherein the system (1200) provides a text box (1205), wherein a text is entered. For an illustration purpose, a user inserts a paragraph comprising of several sentences in the text box (1205). The screen shot provides for an option to analyze (1210) as well as reset (1215) button to the user. Strictly for an illustration purpose, the user inserts following English language complex corpus of sentences:

Economists have often called the financial crisis of 2007-2008, frequently referred to as the Global Financial Crisis, the worst financial crisis since the Great Depression. The financial crisis caused collapse of several large financial institutions, including the Lehman Brothers. Economists have shown that in the years before the crisis, irresponsible mortgage lending began to take root in the banking system. Bankers, incentivized by low interest rates, began to hunt for riskier assets that offered higher returns. Bankers did not take into consideration that mortgage-backed securities began to slump in value as they continued their lending practices. When the housing market turned, a chain reaction exposed fragilities in the financial system. The financial crisis, which manifested as a liquidity crisis, can be dated from Aug. 9, 2007. The housing market suffered tremendously, resulting in evictions, foreclosure and prolonged unemployment. The financial crisis played a significant role in decline in consumer wealth, particularly on the housing market. The housing market started to slow after several years of soaring price growth. The housing market did not begin to grow even after bail out of large banks. Economists have shown that the financial crisis of 2007-2008 has been the main cause of economic down turn of the past few years.

The complex English language corpus is a combination of 12 sentences. After initiation of analysis (1210), the system organizes the text i.e. the independent sentences into three different heads namely “Agent”, “Topic” and “Object” (1220). Further, the organized data in different heads can be presented in visual form for better deciphering of the contents (1225).

As illustrated in FIGS. 10 (B), 10 (C), 10 (D) and 10 (E), the system automatically picks up each and every sentence (1230) of the complex corpus and bifurcates it into Agent (1235), Topic (1240) and Object (1245). Strictly for the illustration purpose a few of the sentence from the complex corpus are presented here for ease of understanding:

| Agent | Topic | Object |
|---|---|---|
| Economists | have often | the financial crisis of 2007-2008 |
| | called | frequently referred to as Global |
| | | Financial Crisis, the worst |
| | | financial crisis since Great |
| | | Depression. |
| The financial crisis | caused | collapse of several large |
| | | financial institutions, including |
| | | the Lehman Brothers |
| Economists | have shown | shown that in the years before |
| | | the crisis, irresponsible |
| | | mortgage lending began to take |
| | | root in the banking system |
| Bankers | Incentivized | by low interest rates, began to |
| | | hunt for riskier assets that |
| | | offered higher returns. |
| Bankers | did not take | into consideration that |
| | | mortgage-backed securities |
| | | began to slump in value as they |
| | | continued their lending |
| | | practices. |
| the housing market | turned | a chain reaction exposed |
| | | fragilities in the fmancial |
| | | system. |
| The financial crisis | manifested | as a liquidity crisis, can be dated |
| | | from Aug. 9, 2007 |
| The housing market | suffered | in evictions, foreclosure and |
| | tremendously, | prolonged unemployment. |
| | resulting | |
| The financial crisis | played | a significant role in decline in |
| | | consumer wealth, particularly on |
| | | the housing market. |
| The housing market | started to slow | after several years of soaring |
| | | price growth. |
| The housing market | did not begin | grow even after bail out of large |
| | to | banks. |
| Economists | have shown | that the financial crisis of 2007- |
| | | 2008 has been the main cause of |
| | | economic down turn of the past |
| | | few years. |

Further, after organizing the sentences of the corpus and preparing a catalogue of sentences under different heads, as illustrated in FIGS. 10 (F) and (G), the system organizes the information in the form of graphics (1250) and (1255), correlating to different heads viz. Agent, Topic and Object as mentioned herein below.

| Agent | Topic | Object |
|---|---|---|
| Bankers | incentivized | By low interest rates, began to |
| | | hunt for riskier assets that |
| | | offered higher returns |
| Bankers | did not take | into consideration that |
| | | mortgage-backed securities |
| | | began to slump in value as they |
| | | continued their lending practices |
| Economists | have often | the financial crisis (2007-2008) |
| | called | frequently referred to as Global |
| | | Financial Crisis, the worst |
| | | financial crisis since Great |
| | | Depression. |
| Economists | have shown | that in the years before the crisis, |
| | | irresponsible mortgage lending |
| | | began to take root in the banking |
| | | system |
| Economics | have shown | the financial crisis of 2007-2008 |
| | | has been the main cause of |
| | | economic down turn of the past |
| | | few years. |
| The financial crisis | Caused | collapse of several large |
| | | financial institutions, including |
| | | the Lehman Brothers |
| The financial crisis | Manifested | as a liquidity crisis, can be dated |
| | | from Aug. 9, 2007 |
| The financial crisis | played | a significant role in decline in |
| | | consumer wealth, particularly on |
| | | the housing market. |
| the housing market | Turned | a chain reaction exposed |
| | | fragilities in the financial |
| | | system. |
| The housing market | suffered | in evictions, foreclosure and |
| | tremendously, | prolonged unemployment. |
| | resulting | |
| The housing market | started to slow | after several years of soaring |
| | | price growth. |
| The housing market | did not begin | even after bail out of large |
| | to grow | banks. |

The illustrations 10 (F) and 10 (G) illustrate a novel methodology for creating a conceptual map of a given text, classifying semantic macro-areas, positions of Agents vis-à-vis Topics and Objects. In addition invention assigns a reference system for analyzing denotative content of discourse reorganizing text into a new order in with the position of discursive Agents are highlighted. As above illustrated, the system is based upon a database of sentences wherein it is possible to associate denotative as well as connotative meanings within and across sentences. The system deciphers grammatical relations among sentence components and organizes the information from within and across sentences. From the generated results, the program creates a database, axiologically categorizing subject-matters within a given text or across and among unrelated texts. The system then discloses a discoursive map of the positions of Agent/s in a given text of multiple sentences vis-à-vis particular Topic/s and Object/s using discourse analysis methodology. From the vast pool of data, this discursive analytics methodology gives users the capability to automatically generate accurate analysis of a given text to aid in the selection and categorization of Agents and contested subjects of analysis. Thus, the system as disclosed in the present invention along with its various embodiments facilitates its user to search for an accurate result by employing the grammatical search system as discussed herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

I/We claim:

1. A system for automatic parsing of grammatical categories from within or across sentences comprising:
a. at least one user connected to at least one user computer, said user computer having a processor, memory, input and output devices;
b. a server, wherein said server has an operating system, a search module, a sentence parser, a keyword matcher and an analyzer;
c. a database, capable of storing data, information, text query and the like;
d. network communication connecting said server and database

2. A system for automatic parsing of grammatical categories from within or across sentences claimed in claim 1, wherein grammatical categories are Agent, Topic and Object.

3. A system for automatic parsing of grammatical categories from within or across sentences as claimed in claim 1, wherein the processor executes computer language instructions, code and programs codified to parse the grammatical categories from within or across sentence.

4. A system for automatic parsing of grammatical categories from within or across sentences as claimed in claim 1, wherein the memory is volatile and non-volatile memory includes Random Access Memory (RAM), Static RAM, Dynamic RAM, Read Only Memory (ROM), flash memory, several kind of magnetic storage device and the like, which are capable of storing text query, sentences, data, information generated while parsing the grammatical categories.

5. A system for automatic parsing of grammatical categories from within or across sentences as claimed in claim 1, wherein the input and out devices include a computer keyboard, mouse, scanner, microphone, stylus, a display screen, printer, disk, drives, flash drives and the like, which are capable of facilitating keying-in of information, data, text as well as displaying the same.

6. A system for automatic parsing of grammatical categories from within or across sentences as claimed in claim 1, the operating system residing on the server facilitates managing and operating of the server, if located remotely.

7. A system for automatic parsing of grammatical categories from within or across sentences as claimed in claim 1, the search module identifies relevant key words pertaining to the grammatical categories from the text query.

8. A system for automatic parsing of grammatical categories from within or across sentences as claimed in claim 1, the sentence parser parses the keywords from the text query into grammatical categories.

9. A system for automatic parsing of grammatical categories from within or across sentences as claimed in claim 1, the keyword matcher matches the relevant search results corresponding to the parsed keywords from the database.

10. A system for automatic parsing of grammatical categories from within or across sentences as claimed in claim 1, the analyzer analyze the search results and displays the search results with same or similar grammatical category to that of the keyword.

11. A system for automatic parsing of grammatical categories from within or across sentences as claimed in claim 1, wherein the database is located locally on the server or globally, said database aids in identifying various denotative and connotative meanings of the search terms, its inter-relationship with agents, subjects or topics and the like from the text, data, information, sentences stored in it.

12. A system for automatic parsing of grammatical categories from within or across sentences as claimed in claim 1, the network communication is wired or wireless depending upon the complexity of the system as well as amount of text/sentences to be parsed.

13. A method for automatic parsing of grammatical categories from within or across sentences, said method comprising the steps of:
a. receiving a text query having at least one grammatical category;
b. determining keywords within the text query and its search criteria;
c. evaluating the grammatical category of the keywords;
d. indexing the keywords into corresponding grammatical categories;
e. searching for search results from the same or similar grammatical categories to that of keyword;
f. preparing a conceptual map and displaying the search results.

14. A method for automatic parsing of grammatical categories from within or across sentences as claimed in claim 13, wherein said text query is either a singular sentence or a combination of plurality of sentences in the form of a discourse.

15. A method for automatic parsing of grammatical categories from within or across sentences as claimed in claim 13, wherein at least one grammatical category include an Agent, Topic or Object.

16. A method for automatic parsing of grammatical categories from within or across sentences as claimed in claim 13, wherein the determination of keywords is done on the basis of its search criteria i.e. search to be conducted for keyword as an Agent or Topic or Object or any combination thereof.

17. A method for automatic parsing of grammatical categories from within or across sentences as claimed in claim 13, wherein the evaluation of grammatical categories of keywords is done by using a combination of statistical methods such as shallow parsing, deep parsing and the like.

18. A method for automatic parsing of grammatical categories from within or across sentences as claimed in claim 13, wherein the indexing of keyword includes cataloging of keywords acting as Agent/s, keywords acting as Topic/s, and keywords acting as Object/s.

19. A method for automatic parsing of grammatical categories from within or across sentences as claimed in claim 13, wherein similar search results are searched by crawling the information, data, sentences, text available in database and picking up only those sentences, wherein the keywords with the specific grammatical category are present.

20. A method for automatic parsing of grammatical categories from within or across sentences as claimed in claim 13, wherein the conceptual map includes display of search results in the text, visualization or graphical form.
